(19) United States
(12) Patent Application Publication
(10) Pub. No.: US 2022/0297665 A1
(43) Pub. Date: Sep. 22, 2022

(54) MOTOR CONTROL SYSTEM AND HYBRID ELECTRIC VEHICLE

(71) Applicant: TOYOTA JIDOSHA KABUSHIKI KAISHA, Aichi-ken (JP)

(72) Inventors: Koji MURAKAMI, Toyota-shi (JP); Tatsuya YAMAGUCHI, Nisshin-shi (JP); Kensuke NAKANISHI, Kiyosu-shi (JP)

(21) Appl. No.: 17/685,386

(22) Filed: Mar. 3, 2022

(30) Foreign Application Priority Data
Mar. 19, 2021 (JP) 2021-045468

(51) Int. Cl. B60W 20/10; B60W 20/40; B60W 20/20; B60L 15/00

(52) U.S. Cl. CPC B60W 20/10; B60W 20/40; B60W 20/20; B60L 15/007

(57) ABSTRACT

A motor control system includes an MG, a battery, an SMR, and an MG-ECU. The MG-ECU is configured to control the MG in accordance with an instruction provided through communication. The MG-ECU is configured to execute autonomous power generation control of the MG in an event of a fault in the communication. The autonomous power generation control is control in which the MG-ECU causes the MG to generate a predetermined voltage not in accordance with the instruction. The MG-ECU is configured to, when a fault is detected in the communication, start the autonomous power generation control after the SMR has finished switching from an off state to an on state.

### CROSS-REFERENCE TO RELATED APPLICATION

This application claims priority to Japanese Patent Application No. 2021-045468 filed on Mar. 19, 2021, incorporated herein by reference in its entirety.

### BACKGROUND

### 1. Technical Field

The disclosure relates to a motor control system and, more particularly, to a motor control system including a motor generator.

### 2. Description of Related Art

Japanese Unexamined Patent Application Publication No. 2014-079081 (JP 2014-079081 A) describes a vehicle including a relay provided in an electric circuit between a motor generator and an electrical storage device. When the relay switches from an off state to an on state, current flows through the electric circuit via the relay.

### SUMMARY

When a motor controller is configured to control the motor generator in accordance with an instruction provided through communication, the motor controller is not able to receive the instruction in the event of a communication fault. Therefore, in the event of a communication fault, the motor controller may execute autonomous power generation control for causing the motor generator to generate a predetermined voltage not in accordance with the instruction.

When the relay is provided between the motor generator and the electrical storage device as described in JP 2014-079081 A, the relay may be damaged depending on the timing at which autonomous power generation control is started in the event of a communication fault as described above.

The disclosure provides a motor control system capable of appropriately protecting a relay between a motor generator and an electrical storage device at the time when autonomous power generation control is executed, and a hybrid electric vehicle including the system.

An aspect of the disclosure relates to a motor control system. The motor control system includes a motor generator, an electrical storage device, a relay, and a first controller. The motor generator is configured to generate electric power by receiving a rotating force. The electrical storage device is configured to receive electric power generated by the motor generator. The relay is provided between the motor generator and the electrical storage device. The first controller is configured to control the motor generator in accordance with an instruction provided through communication. The first controller is configured to execute autonomous power generation control of the motor generator in an event of a fault in the communication. The autonomous power generation control is control in which the first controller causes the motor generator to generate a predetermined voltage not in accordance with the instruction. The first controller is configured to, when the communication fault is detected, start the autonomous power generation control after the relay has finished switching from an off state to an on state.

With the above configuration, in the event of a fault in the communication as described above, the autonomous power generation control is started after the relay has finished switching from the off state to the on state. For this reason, it is possible to prevent a relay fault that occurs at the time when the relay is switched from the off state to the on state during execution of the autonomous power generation control.

The motor control system may further include a second controller. The second controller may be configured to communicate with the first controller and output the instruction to the first controller. The second controller may be configured to control the relay. The first controller may be configured to start the autonomous power generation control when a first threshold time has elapsed from time at which a voltage input from the electrical storage device to the motor generator through the relay reaches a threshold voltage. The threshold voltage may be a voltage that at least needs to be input to the motor generator in order for the first controller to execute the autonomous power generation control.

With the above configuration, even in the event of a communication fault that the first controller is not able to obtain information indicating that the second controller has switched the relay from the off state to the on state, the first controller is able to estimate that the relay has reliably finished switching after a lapse of the first threshold time. Thus, in the event of such a communication fault as well, the autonomous power generation control is started on the assumption that the relay has finished switching, so it is possible to prevent a relay fault.

The motor control system may further include an internal combustion engine configured to generate the rotating force. The first controller may be configured to start the autonomous power generation control when a second threshold time has elapsed from time at which the number of revolutions of the internal combustion engine reaches a threshold number of revolutions.

With the above configuration, it is possible to start the autonomous power generation control under the condition that the motor generator is reliably rotating to such an extent that the motor generator is able to generate electric power.

The second controller may be configured to make a diagnosis on whether there is a fault in the relay in accordance with a voltage input to the motor generator. Time at which the first controller starts the autonomous power generation control may be later than time at which the second controller has finished making a diagnosis that there is no fault in the relay.

With the above configuration, it is possible to avoid a situation in which the autonomous power generation control is started under the condition that there is a fault in the relay.

Another aspect of the disclosure relates to a hybrid electric vehicle. The hybrid electric vehicle includes the above-described motor control system, and an internal combustion engine configured to generate the rotating force.

With the hybrid electric vehicle, in the event of a fault in the communication as described above, the autonomous power generation control is started after the relay has finished switching from the off state to the on state. For this reason, it is possible to prevent a relay fault that occurs at the time when the relay is switched from the off state to the on state during execution of the autonomous power generation control.

According to the aspects of the disclosure, it is possible to provide a motor control system capable of appropriately protecting a relay between a motor generator and an electrical storage device during execution of autonomous power generation control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the overall configuration of a vehicle to which a motor control system according to an embodiment is applied;

FIG. 2 is a timing chart for illustrating a process to be executed in relation to autonomous power generation control in the event of a communication fault in a comparative example;

FIG. 3 is a timing chart for illustrating a process to be executed in relation to autonomous power generation control in the event of a communication fault in the present embodiment; and

FIG. 4 is a flowchart showing an example of a process related to autonomous power generation control.

### DETAILED DESCRIPTION OF EMBODIMENTS

Hereinafter, an embodiment will be described with reference to the accompanying drawings. Like reference signs denote the same or corresponding portions in the drawings, and the description thereof will not be repeated.

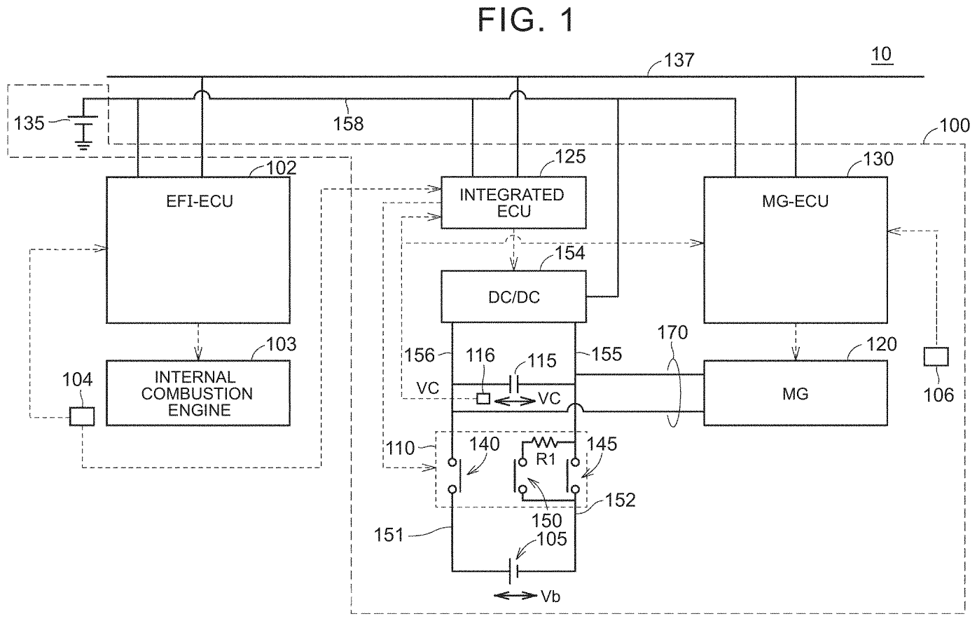

FIG. 1 is a block diagram showing the overall configuration of a vehicle to which a motor control system according to the present embodiment is applied. The vehicle 10 is a so-called mild hybrid electric vehicle. The vehicle 10 runs when a motor generator (MG) is supplementarily driven for an internal combustion engine.

As shown in FIG. 1, the vehicle 10 includes a motor control system 100, an electrical fuel injection (EFI)-electronic control unit (ECU) 102, the internal combustion engine 103, rotation speed sensors 104, 106, and a bus 137.

The motor control system 100 includes a battery 105, a system main relay (SMR) 110, a capacitor 115, a voltage sensor 116, the motor generator (MG) 120, a battery 135, a DC-DC converter 154, an MG-ECU 130, and an integrated ECU 125.

The battery 105 is a battery pack including a plurality of cells. Each of the cells is a secondary battery, such as a lithium ion battery, a lead acid battery, and a nickel-metal hydride battery. The battery 105 is illustrated as an example of an electrical storage device configured to be charged and discharged. Instead of the battery 105, an electrical storage device made up of an electrical storage element, such as an electrical double-layer capacitor, may be used. The battery 105 stores electric power for driving the vehicle 10. A voltage Vb between both ends of the battery 105 is, for example, 48 V.

The SMR 110 includes contacts 140, 145, 150 and a limiting resistor RE The contact 140 is provided between a power line 156 and a power line 151 connected to the positive electrode of the battery 105. The contact 145 is provided between a power line 155 and a power line 152 connected to the negative electrode of the battery 105. The contact 150 is connected in series with the limiting resistor RE The contact 150 and the limiting resistor R1 are provided in parallel with the contact 145.

The capacitor 115 is provided between the power lines 155, 156. The voltage sensor 116 detects a voltage VC between both ends of the capacitor 115. A detected value of the voltage sensor 116 is output to the integrated ECU 125 and the MG-ECU 130 (all of which will be described later).

The MG 120 is, for example, a three-phase permanent magnet synchronous motor. The MG 120 is coupled to the rotary shaft of the internal combustion engine 103 (described later) via a belt (not shown). The output torque of the MG 120 is transmitted to the rotary shaft of the internal combustion engine 103 via the belt and is used to mainly assist the rotation of the internal combustion engine 103.

The MG 120 is electrically connected to the power lines 155, 156 through power lines 170. The MG 120 is configured to generate electric power by using a rotating force received via the belt during regenerative braking of the vehicle 10 or when power generation is requested. Electric power generated by the MG 120 is stored in the battery 105. The MG 120 is configured to generate electric power by receiving electric power at the voltage VC when the voltage VC of the power lines 170 is higher than or equal to a threshold voltage (described later).

The battery 135 is a battery for auxiliaries (for example, 12 V). The battery 135 supplies operating power to the EFI-ECU 102, the integrated ECU 125, and the MG-ECU 130 (all of which will be described later) through a power line 158. The battery 135 receives electric power supplied from the DC-DC converter 154.

The DC-DC converter 154 is provided between the power line 158 and both power lines 155, 156. The DC-DC converter 154 is configured to step down (convert) electric power output from the battery 105 and output the electric power to the power line 158. The stepped-down electric power is stored in the battery 135. The DC-DC converter 154 operates in accordance with a control instruction from the integrated ECU 125.

The MG-ECU 130 is configured to control the MG 120 in accordance with an instruction (torque command or the like) provided through communication from the integrated ECU 125. When communication is established between the MG-ECU 130 and the integrated ECU 125, the MG-ECU 130 is able to receive, from the integrated ECU 125, information indicating whether the relay 110 is in an on state or an off state. The MG-ECU 130 is able to receive the instruction and the information through the bus 137 that performs communication by using a controller area network (CAN). The MG-ECU 130 includes a processor, such as a central processing unit (CPU), and a memory made up of a read only memory (ROM), a random access memory (RAM), and the like (all of which are not shown).

The internal combustion engine 103 is, for example, a gasoline engine or a diesel engine. A driving force of the vehicle 10 is generated by rotation of the internal combustion engine 103. The internal combustion engine 103 is coupled to the MG 120 through the belt. For this reason, while the vehicle 10 is running, rotation of the internal combustion engine 103 can be assisted by rotation of the MG 120 via the belt. When the system of the vehicle 10 starts up, a starter (not shown) for starting the internal combustion engine 103 operates, with the result that rotation of the internal combustion engine 103 is started.

The EFI-ECU 102 controls the internal combustion engine 103. When the rotation speed of the internal combustion engine 103 exceeds a threshold rotation speed at the time when the system of the vehicle 10 starts up, the EFI-ECU 102 starts fuel injection of the internal combustion engine 103 and starts the internal combustion engine 103.

The rotation speed sensor 104 detects the rotation speed (the number of revolutions per unit time) of the internal combustion engine 103. The rotation speed is output to the EFI-ECU 102 and the integrated ECU 125.

The rotation speed sensor 106 detects the rotation speed of the MG 120. A detected value of the rotation speed sensor 106 is output to the MG-ECU 130.

The integrated ECU 125 controls the entire vehicle 10. The integrated ECU 125, for example, controls the open or closed state of each of the contacts 140, 145, 150 in the SMR 110. For example, when the system of the vehicle 10 starts up (when the contacts 140, 145, 150 are open), the integrated ECU 125 makes a diagnosis on whether the contact 140 is welded, by closing (conducting electricity through) the contact 145 or the contact 150.

When the detected value (voltage VC) of the voltage sensor 116 begins to increase at the time of closing the contact 145 or the contact 150, the integrated ECU 125 makes a diagnosis that the contact 140 is welded. On the other hand, when the voltage VC does not increase in the above case, the integrated ECU 125 makes a diagnosis that the contact 140 is not welded.

Subsequently, the integrated ECU 125 similarly makes a diagnosis on whether the contact 145 or the contact 150 is welded in accordance with the detected value by opening the closed contact 145 or contact 150 and then closing the contact 140.

After the integrated ECU 125 makes a diagnosis on whether the contact 145 or the contact 150 is welded, the integrated ECU 125 further closes the contact 150. Thus, while current flowing through the capacitor 115 is limited by the limiting resistor R1, precharge of the capacitor 115 is performed. The precharge is performed to reduce rush current that flows through the capacitor 115 when the integrated ECU 125 closes the contact 145. The integrated ECU 125 determines whether precharge of the capacitor 115 is started based on whether the detected value of the voltage sensor 116 has increased.

When the detected value of the voltage sensor 116 is not increased, the integrated ECU 125 determines that precharge of the capacitor 115 is not started. In this case, it is presumable that there is a break between the power lines 151, 156 or between the power lines 152, 155 or the contact 150 of the SMR 110 remains open as a result of the fact that a control signal is not transmitted from the integrated ECU 125 to the SMR 110 due to a fault of a wire between the integrated ECU 125 and the SMR 110. For this reason, in the above case, the integrated ECU 125 makes a diagnosis that there is a fault in the SMR 110.

On the other hand, when the detected value of the voltage sensor 116 has increased, the integrated ECU 125 determines to start precharge of the capacitor 115. After that, the integrated ECU 125 determines to stop precharge of the capacitor 115 based on the fact that the detected value of the voltage sensor 116 has increased to the voltage Vb of the battery 105. Subsequently, the integrated ECU 125 closes the contact 145 and opens the contact 150. Thus, the SMR 110 has finished switching from the off state to the on state.

The fact that the SMR 110 is in the “off state” means a state where at least two of the contacts 140, 145, 150 are open. The fact that the SMR 110 is in the “on state” means a state where both the contacts 140, 145 are closed and the contact 150 is open. When the system of the vehicle 10 starts up, the SMR 110 takes a “half on state” (a state where the contacts 140, 150 are closed, while the contact 145 is open) during precharge of the capacitor 115 until the SMR 110 is switched from the off state to the on state.

As described above, the integrated ECU 125 opens or closes the contacts 140, 150, 145 as needed when the system of the vehicle 10 starts up. While the contacts are opened or closed, the integrated ECU 125 makes a diagnosis on whether there is a fault (for example, a weld, a break, a wiring fault, or the like) in the SMR 110 in accordance with the voltage VC detected by the voltage sensor 116. When there is a fault in the SMR 110, the integrated ECU 125, for example, outputs an instruction to the MG-ECU 130 to stop the MG 120.

The integrated ECU 125 is electrically connected to each of the EFI-ECU 102 and the MG-ECU 130 through the bus 137. The integrated ECU 125 is configured to communicate with the ECUs through the bus 137 and control the entire vehicle 10 by outputting an instruction to the ECUs.

The integrated ECU 125 is configured to output a torque command value for the MG 120 to the MG-ECU 130. The MG-ECU 130 drives the MG 120 based on the torque command value. The integrated ECU 125 is configured to output the state of the SMR 110 (for example, whether the SMR 110 is in the on state, the half on state, or the off state) to the MG-ECU 130. The integrated ECU 125, as well as the MG-ECU 130, includes a processor, such as a CPU, and a memory made up of a ROM, a RAM, and the like (all of which are not shown).

The integrated ECU 125 outputs an instruction to start the internal combustion engine 103 to the EFI-ECU 102 when the system of the vehicle 10 starts up.

When a fault occurs in communication between the MG-ECU 130 and the integrated ECU 125, the MG-ECU 130 is not able to receive an instruction from the integrated ECU 125 through the bus 137. Therefore, in this case, the MG-ECU 130 may execute autonomous power generation control for causing the MG 120 to generate a predetermined voltage not in accordance with the instruction.

Here, when such a fault occurs in the communication, the SMR 110 may be damaged depending on the timing at which autonomous power generation control is started. For this reason, when autonomous power generation control is executed in the event of a fault in the communication, it is desired to appropriately protect the SMR 110.

In the present embodiment, a control method to be performed by the MG-ECU 130 for appropriately protecting the SMR 110 in such a case will be described. Initially, before the control method is described, a comparative example in the case where the control is not executed will be described.

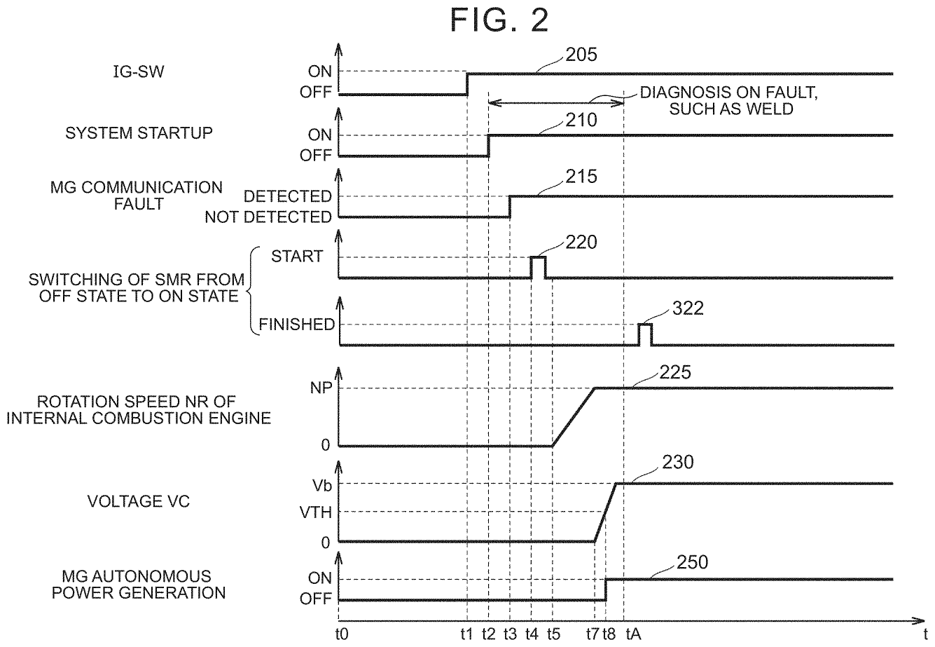

FIG. 2 is a timing chart for illustrating a process to be executed in relation to the autonomous power generation control in the event of a communication fault in the comparative example.

In FIG. 2, the abscissa axis represents time. The ordinate axes respectively represent, in order from above, on or off of an ignition switch, whether the motor control system 100 is started up, whether a communication fault is detected in the MG-ECU, whether the SMR 110 is started to switch from the off state to the on state, whether the SMR 110 has finished switching, the rotation speed of the internal combustion engine 103, the voltage VC of the power lines 170, and whether the autonomous power generation control is being executed by the MG-ECU (on or off of the control).

At time t1, the state of the ignition switch switches from off to on (line 205).

At time t2, in response to the switching of the ignition switch, the motor control system 100 (including the integrated ECU and the MG-ECU) and the EFI-ECU 102 start up (line 210). Then, the integrated ECU starts making a diagnosis on whether there is a fault in the SMR 110 in accordance with the voltage VC (line 230) detected by the voltage sensor 116 (FIG. 1). The diagnosis continues to time tA. In the example of FIG. 2, there is no fault in the SMR 110. Time tA is determined based on a time required to finish making a diagnosis that there is no fault in the SMR 110 and time t2 at which the diagnosis is started.

At time t3, the MG-ECU detects that there is a fault in communication with the integrated ECU (line 215). The MG-ECU, for example, determines that there is a fault in the communication based on the fact that the MG-ECU is not able to receive an instruction from the integrated ECU.

At time t4, the integrated ECU starts switching the SMR 110 from the off state to the on state in response to startup of the motor control system 100 at time t2 (line 220). Here, switching the SMR 110 from the off state to the on state means a series of operations that, with precharge of the capacitor 115, the contacts 140, 145, 150 are opened or closed as needed during times from time at which the contact 140 is closed (the SMR 110 switches from the off state to the half on state) to time at which the contact 150 is opened (the SMR 110 switches from the half on state to the on state) (line 322).

Specifically, at time t4, the integrated ECU closes the contact 140 under the condition that the contacts 140, 145, 150 of the SMR 110 are open. Then, the integrated ECU makes a diagnosis on whether the contact 145 or the contact 150 is welded during times from time t4 to time t7 (described later).

At time t5, the integrated ECU outputs an instruction to start the internal combustion engine 103 to the EFI-ECU 102. The EFI-ECU 102 operates the starter in accordance with the instruction to start the internal combustion engine 103. Thus, the rotation speed NR of the internal combustion engine 103 begins to increase (line 225). After the rotation speed NR increases to a predetermined value NP, a state where the rotation speed NR is the predetermined value NP continues.

At time t7 at which a welding diagnosis on the contacts 145, 150 finishes, the integrated ECU closes the contact 150 of the SMR 110. Thus, the SMR 110 switches from the off state to the half on state. Then, precharge of the capacitor 115 is started, and the voltage VC begins to increase (line 230). After that, the integrated ECU makes a diagnosis on whether there is a fault, such as a break, in the SMR 110 in accordance with the detected value (voltage VC) of the voltage sensor 116.

At time t8, the voltage VC reaches the threshold voltage VTH (line 230). The threshold voltage VTH is a voltage at least needed to be input from the power lines 170 to the MG 120 in order for the MG 120 to generate electric power through autonomous power generation control. In this comparative example, at time t8 at which the voltage VC reaches the threshold voltage VTH, the MG-ECU starts autonomous power generation control (line 250).

Here, at time t8, the contacts 140, 150 are closed, the SMR 110 is in the half on state, and the voltage VC of the power lines 170 has not increased to the voltage Vb yet (line 230). For this reason, when the predetermined voltage output from the MG 120 through autonomous power generation control is higher than the voltage VC (threshold voltage VTH) of the power lines 170 at time t8 at which the autonomous power generation control is started, an excessive current may rapidly flow into the contacts 140, 150 from the MG 120 through the power lines 170 just after the start of the autonomous power generation control.

In this way, when autonomous power generation control is started at time t8 at which the SMR 110 is in the half on state as in the case of the comparative example in the case where there is a fault in communication between the integrated ECU and the MG-ECU, it may be not possible to appropriately protect the SMR 110.

Therefore, in the present embodiment, when a fault occurs in communication between the integrated ECU 125 and the MG-ECU 130, after the SMR 110 has finished switching from the off state to the on state (a series of switches, that is, off state half on state on state), the MG-ECU 130 starts autonomous power generation control.

For this reason, in the present embodiment, a potential difference between the voltage VC at the start of autonomous power generation control and the predetermined voltage output from the MG 120 through the autonomous power generation control is less than the potential difference in the case of the comparative example (FIG. 2). Therefore, just after the start of autonomous power generation control, current flowing from the MG 120 to the contacts 140, 150 is less than the current in the case of the comparative example (FIG. 2). As a result, it is possible to appropriately protect the SMR 110 during autonomous power generation control to be executed by the MG-ECU 130.

Here, after time t3, there is a fault in communication between the integrated ECU 125 and the MG-ECU 130, so the MG-ECU 130 is not able to obtain information indicating that the SMR 110 has finished switching from the off state to the on state by the integrated ECU 125, from the integrated ECU 125 through the bus 137 (FIG. 1). In other words, from the viewpoint of protecting the SMR 110, it is desirable that autonomous power generation control is started after the SMR 110 has finished switching; however, the MG-ECU 130 is not able to obtain when the SMR 110 has finished switching from the integrated ECU 125 due to the communication fault. Thus, the MG-ECU 130 is not able to obtain, from the integrated ECU 125, information indicating time for starting autonomous power generation control.

For this reason, a method in which the MG-ECU 130 estimates time at which the SMR 110 has reliably finished switching in order to protect the SMR 110 when autonomous power generation control is executed in the event of a communication fault will also be described below.

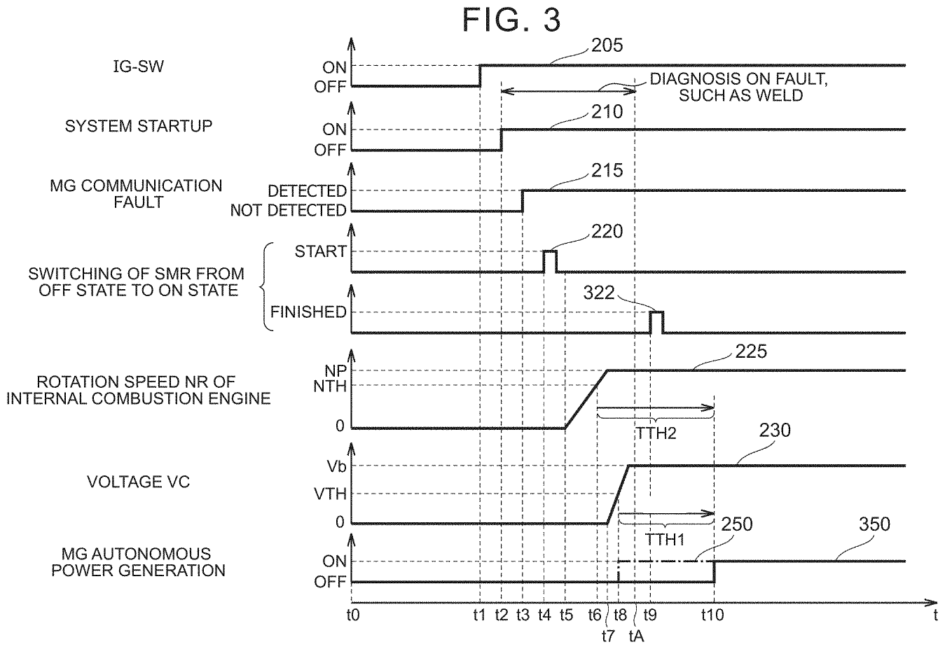

FIG. 3 is a timing chart for illustrating a process to be executed in relation to the autonomous power generation control in the event of a communication fault in the present embodiment.

In FIG. 3, the abscissa axis represents time. The ordinate axes respectively represent, in order from above, on or off of the ignition switch, whether the motor control system 100 is started up, whether a communication fault is detected in the MG-ECU 130, whether the SMR 110 is started to switch from the off state to the on state, whether the SMR 110 has finished switching, the rotation speed of the internal combustion engine 103, the voltage VC of the power lines 170, and on or off of autonomous power generation control to be executed by the MG-ECU 130.

In the present embodiment, in the MG-ECU 130, the rotation speed NR of the internal combustion engine 103 is calculated from a detected value of the rotation speed sensor 106. The rotary shaft of the MG 120 and the rotary shaft of the internal combustion engine 103 are coupled to each other by the belt, and the MG-ECU 130 is able to calculate the rotation speed NR of the internal combustion engine 103 from the detected value of the rotation speed sensor 106.

In the present embodiment, the processes of the EFI-ECU 102, integrated ECU 125, and MG-ECU 130 between time t1 and time t5 and at time t7 are similar to the processes in the above-described comparative example (FIG. 2) (lines 205, 210, 215, 220, 225, 230).

At time t6, the rotation speed NR of the internal combustion engine 103 reaches a threshold rotation speed NTH (line 225). The threshold TH is, for example, a lowest idle rotation speed (the lowest rotation speed of the internal combustion engine 103 at the time when the internal combustion engine 103 is being driven in a no-load state). When the rotation speed NR exceeds the threshold rotation speed NTH, the integrated ECU 125 outputs an instruction to the EFI-ECU 102 to start the internal combustion engine 103. The EFI-ECU 102 starts fuel injection of the internal combustion engine 103 in accordance with the instruction and starts the internal combustion engine 103. Subsequently, after the rotation speed NR increases to the predetermined value NP, a state where the rotation speed NR is the predetermined value NP continues.

In the present embodiment, an elapsed time from when the rotation speed NR of the internal combustion engine 103 reaches the threshold rotation speed NTH (from the beginning of starting the internal combustion engine 103) is used by the MG-ECU 130 to estimate whether the MG 120 is sufficiently rotating to such an extent that the MG 120 is able to generate electric power, as will be described later.

At time t9, the integrated ECU 125 has finished switching the SMR 110 from the off state to the on state (line 322). Specifically, the integrated ECU 125, after precharge of the capacitor 115 is stopped, closes the contact 145 and opens the contact 150 in the half on state of the SMR 110 where the contacts 140, 150 are closed. Thus, as a result of switching of the SMR 110 from the half on state to the on state, the SMR 110 has finished switching from the off state to the on state.

Here, after time t9, precharge of the capacitor 115 is already stopped, so the voltage VC has increased to the voltage Vb. For this reason, the voltage VC (voltage Vb) at the start of autonomous power generation control after time t9 is higher than the voltage VC (threshold voltage VTH) at time t8 in the case of the comparative example. Therefore, after time t9, a potential difference between the voltage VC at the start of autonomous power generation control and the predetermined voltage output from the MG 120 through the autonomous power generation control is less than the potential difference of the comparative example.

For this reason, when autonomous power generation control is started after time t9, current flowing from the MG 120 to the contacts 140, 150 just after the start of the control is less than the current in the case of the comparative example. Therefore, when autonomous power generation control is started after time t9, it is possible to reduce the degree of wear of the SMR 110 as compared to when the control is started at time t8 as in the case of the comparative example.

Here, as described above, the MG-ECU 130 is not able to obtain information (line 322) that the integrated ECU 125 has finished switching the SMR 110 from the off state to the on state at time t9, from the integrated ECU 125 through the bus 137 (FIG. 1) as described above.

Hereinafter, a method for appropriately determining the timing for the MG-ECU 130 to start autonomous power generation control even when there is a communication fault as described above will be described.

Different from the case of the comparative example, to appropriately protect the SMR 110, the timing to start autonomous power generation control just needs to be after the SMR 110 switches to the on state. Specifically, the voltage VC of the power lines 170 just needs to reach the voltage Vb at the start of autonomous power generation control.

Therefore, in the present embodiment, when a first condition that a threshold time TTH1 has elapsed from time t8 at which the voltage VC of the power lines 170 has reached the threshold voltage VTH is satisfied, the MG-ECU 130 estimates that the SMR 110 has finished switching from the off state to the on state.

Here, the threshold time TTH1 is appropriately determined in advance such that, when an elapsed time from time t8 is longer than or equal to the threshold time TTH1, the voltage VC of the power lines 170 reliably already reaches the voltage Vb higher than the threshold voltage VTH. Therefore, when an elapsed time from time t8 is longer than or equal to the threshold time TTH1, the MG-ECU 130 is able to estimate that the SMR 110 has reliably finished switching from the off state to the on state (that is, time after a lapse of the threshold time TTH1 from time t8 is reliably later than time t9). Thus, in this case, the MG-ECU 130 is able to protect the relay 110 when autonomous power generation control is started.

Autonomous power generation control is preferably started in a state where the MG 120 is sufficiently rotating to such an extent that the MG 120 is able to generate electric power. For this reason, the MG-ECU 130 may start autonomous power generation control when the condition that a time has sufficiently elapsed from the beginning of the start of the internal combustion engine 103 is further satisfied. Specifically, when a second condition that a threshold time TTH2 has elapsed from time t6 at which the rotation speed NR of the internal combustion engine 103 has reached the threshold rotation speed NTH (start beginning time of the internal combustion engine 103) is satisfied in addition to the first condition, the MG-ECU 130 may start autonomous power generation control.

Here, the threshold time TTH2 is appropriately determined in advance such that, when an elapsed time from time t6 is longer than or equal to the threshold time TTH2 (second condition), the rotation speed NR of the internal combustion engine 103 reliably already reaches the predetermined value NP. Since the threshold time TTH2 is determined in this way, the MG 120 coupled to the internal combustion engine 103 is considered to be in a state where the MG 120 is sufficiently rotating to such an extent that the MG 120 is able to generate electric power in the above case.

For example, under the condition that the rotation speed NR has not reached the threshold rotation speed NTH (the internal combustion engine 103 is not started), the MG 120 is not in a state where the MG 120 is sufficiently rotating to such an extent that the MG 120 is able to generate electric power by receiving a rotating force transmitted from the internal combustion engine 103 through the belt. Therefore, time at which the MG-ECU 130 starts autonomous power generation control is preferably later than time t6 at which the rotation speed NR reaches the threshold rotation speed NTH.

As described above, when the threshold time TTH1 and the threshold time TTH2 are determined, the MG-ECU 130 is able to estimate that, at time t10 after a lapses of these times, the SMR 110 has reliably finished switching from the off state to the on state (first condition) under the condition that the MG 120 is sufficiently rotating to such an extent that the MG 120 is able to generate electric power (second condition). Thus, the MG-ECU 130 determines time t10 as time for starting autonomous power generation control.

Then, the MG-ECU 130 starts autonomous power generation control of the MG 120 at time t10 (line 350). As a result, as compared to the comparative example (alternate long and short dashed line 250), it is possible to appropriately protect the SMR 110.

In the example of FIG. 3, for the sake of simplification of illustration, a time point at which the threshold time TTH1 has elapsed from time t8 and a time point at which the threshold time TTH2 has elapsed from time t6 are assumed as the same time t10; however, these time points may be different from each other. In this case, the MG-ECU 130, for example, determines any later one of these time points as time for starting autonomous power generation control.

Incidentally, from time t2 to time tA, the integrated ECU 125 is making a diagnosis on whether there is a fault (a weld, a break, or the like) in the SMR 110. Different from the example of FIG. 3, during then, if there is a fault in the SMR 110, a situation in which autonomous power generation control is started by the MG-ECU 130 is not preferable. Specifically, in the above case, the integrated ECU 125 may not be able to switch between supply and interruption of electric power to be transferred between the battery 105 and the MG 120, so it is presumably not preferable that autonomous power generation control is started.

For this reason, time t10 at which autonomous power generation control is started is preferably later than time tA at which a diagnosis that there is no fault in the SMR 110 has been made.

Therefore, the threshold time TTH1 and the threshold time TTH2 are appropriately determined in advance such that time t10 is later than time tA at which a diagnosis that there is no fault in the SMR 110 has been made. Thus, only after time tA at which a diagnosis that there is no fault in the SMR 110 has been made, autonomous power generation control of the MG 120 is started. As a result, it is possible to avoid a situation in which autonomous power generation control is started under the condition that there is a fault in the SMR 110.

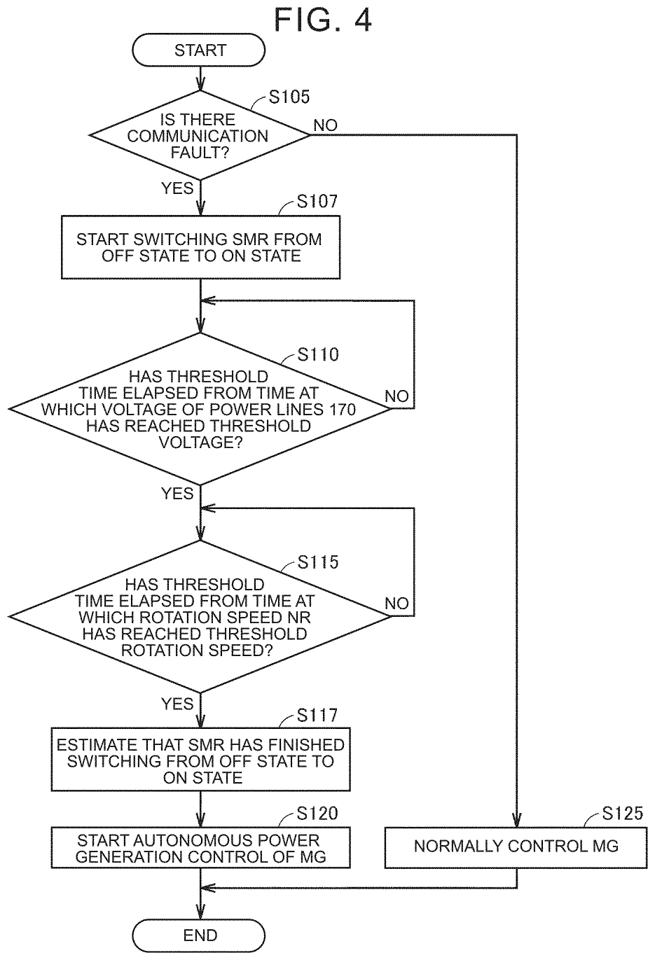

FIG. 4 is a flowchart showing an example of a process related to the autonomous power generation control. In the following description, FIG. 3 will be referenced as needed. The flowchart is executed when the system of the vehicle 10 starts up.

In step S105, the MG-ECU 130 determines whether there is a fault in communication between the MG-ECU 130 and the integrated ECU 125. When there is no fault in communication between the MG-ECU 130 and the integrated ECU 125 (NO in step S105), the MG-ECU 130 normally controls the MG 120 (step S125). Specifically, the MG-ECU 130 controls the MG 120 in accordance with an instruction received from the integrated ECU 125 via the bus 137 (FIG. 1). After that, the process proceeds to return. On the other hand, when there is a communication fault (YES in step S105), the process proceeds to step S107.

In step S107, the integrated ECU 125 starts switching the SMR 110 from the off state to the on state. Specifically, under the condition that the contacts 140, 145, 150 of the SMR 110 are open, the contact 140 is closed. After that, the process proceeds to step S110.

Here, due to the communication fault, the MG-ECU 130 is not able to obtain, from the integrated ECU 125, information indicating whether the SMR 110 has finished switching from the off state to the on state. For this reason, by determining in step S110 whether the first condition is satisfied and determining in subsequent step S115 whether the second condition is satisfied, the MG-ECU 130 estimates whether the SMR 110 has finished switching under the condition that the MG 120 is sufficiently rotating to such an extent that the MG 120 is able to generate electric power.

In step S110, the MG-ECU 130 determines whether the threshold time TTH1 has elapsed from time t8 at which the voltage VC of the power lines 170 has reached the threshold voltage VH (first condition). When the threshold time TTH1 has elapsed from time t8 (YES in step S110), the MG-ECU 130 estimates that the SMR 110 has reliably already finished switching from the off state to the on state, and the process proceeds to step S115. Otherwise (NO in step S110), the determination process of step S110 is repeated until the threshold time TTH1 elapses from time t8.

In step S115, the MG-ECU 130 determines whether the threshold time TTH2 has elapsed from time t6 at which the rotation speed NR of the internal combustion engine 103, calculated from the detected value of the rotation speed sensor 106, has reached the threshold rotation speed NTH (second condition). When the threshold time TTH2 has elapsed from time t6 (YES in step S115), the MG-ECU 130 estimates that the MG 120 is sufficiently rotating to such an extent that the MG 120 is able to generate electric power, and the process proceeds to step S117. Otherwise (NO in step S115), the determination process of step S115 is repeated until the threshold time TTH2 elapses from time t6.

In step S117, the MG-ECU 130 estimates that the SMR 110 has reliably already finished switching from the off state to the on state under the condition that the MG 120 is sufficiently rotating to such an extent that the MG 120 is able to generate electric power based on the fact that time t10 at which both the first condition and the second condition are satisfied has come. Then, the MG-ECU 130 starts autonomous power generation control of the MG 120 (step S120). After that, a series of processes ends.

As described above, the MG-ECU 130 according to the present embodiment, when a fault occurs in communication between the MG-ECU 130 and the integrated ECU 125, starts autonomous power generation control after the SMR 110 has finished switching from the off state to the on state. Thus, when the autonomous power generation control is executed in the event of the above-described communication fault, it is possible to appropriately protect the SMR 110.

### Modification

In the present embodiment, the vehicle 10 is a hybrid electric vehicle on which the internal combustion engine 103 is mounted. In another aspect, the vehicle 10 may be a battery electric vehicle on which no internal combustion engine 103 is mounted. In this case, instead of the internal combustion engine 103 and the belt, another MG (not shown) different from the MG 120 and a power transmission mechanism for transmitting the rotating force of the other MG to the MG 120 are provided.

Then, in the event of a fault in communication between the MG-ECU 130 and the integrated ECU 125, the other MG rotates to rotate the MG 120 via the power transmission mechanism. In this way, even when the internal combustion engine 103 is not provided, the MG 120 is able to sufficiently rotate to such an extent that the MG 120 is able to generate electric power, so the MG-ECU 130 is able to execute autonomous power generation control similarly to the above-described embodiment.

In the above-described embodiment, the vehicle 10 is a so-called mild hybrid electric vehicle. Alternatively, the vehicle 10 may be a hybrid electric vehicle on which a general driving high-voltage battery (for example, 200 V) is mounted.

In the above-described embodiment, the CAN is used as a communication protocol in the bus 137. Alternatively, another communication protocol may be used instead of the CAN.

In the above-described embodiment, the MG-ECU 130 calculates the rotation speed NR of the internal combustion engine 103 from the detected value of the rotation speed sensor 106. Alternatively, the MG-ECU 130 may take in the detected value of the rotation speed sensor 104.

In the flowchart of FIG. 4, the start of switching of the SMR 110 from the off state to the on state by the integrated ECU 125 (step S107) may be earlier than determination as to whether there is a communication fault (step S105).

The embodiment described above is illustrative and not restrictive in all respects. The scope of the disclosure is not defined by the above description, and is defined by the appended claims. The scope of the disclosure is intended to encompass all modifications within the scope of the appended claims and equivalents thereof.

1. A motor control system comprising:
a motor generator configured to generate electric power by receiving a rotating force;
an electrical storage device configured to receive electric power generated by the motor generator;
a relay provided between the motor generator and the electrical storage device; and
a first controller configured to control the motor generator in accordance with an instruction provided through communication, wherein:
the first controller is configured to execute autonomous power generation control of the motor generator in an event of a fault in the communication;
the autonomous power generation control is control in which the first controller causes the motor generator to generate a predetermined voltage not in accordance with the instruction; and
the first controller is configured to, when a fault is detected in the communication, start the autonomous power generation control after the relay has finished switching from an off state to an on state.

2. The motor control system according to claim 1, further comprising a second controller configured to communicate with the first controller and output the instruction to the first controller, wherein:
the second controller is configured to control the relay;
the first controller is configured to start the autonomous power generation control when a first threshold time has elapsed from time at which a voltage input from the electrical storage device to the motor generator through the relay reaches a threshold voltage; and
the threshold voltage is a voltage that at least needs to be input to the motor generator in order for the first controller to execute the autonomous power generation control.

3. The motor control system according to claim 2, further comprising an internal combustion engine configured to generate the rotating force, wherein
the first controller is configured to start the autonomous power generation control when a second threshold time has elapsed from time at which the number of revolutions of the internal combustion engine reaches a threshold number of revolutions.

4. The motor control system according to claim 2, wherein:
the second controller is configured to make a diagnosis on whether there is a fault in the relay in accordance with a voltage input to the motor generator; and
time at which the first controller starts the autonomous power generation control is later than time at which the second controller has finished making a diagnosis that there is no fault in the relay.

5. A hybrid electric vehicle comprising:
the motor control system according to claim 1; and
an internal combustion engine configured to generate the rotating force.
